(19) United States
(12) Patent Application Publication
(10) Pub. No.: US 2026/0273398 A1
(43) Pub. Date: Sep. 17, 2026

(54) MANAGEMENT OF MULTIPLE HOSTS WITH PREDICTIVE AND SEAMLESS HOST MIGRATION

(71) Applicant: Sony Interactive Entertainment Inc., Tokyo (JP)

(72) Inventors: Edwin Foo, San Mateo, CA (US); Nick Dukellis, San Mateo, CA (US)

(21) Appl. No.: 19/079,206

(22) Filed: Mar. 13, 2025

(51) Int. Cl. A63F 13/358; A63F 13/327

(52) U.S. Cl. CPC A63F 13/358; A63F 13/327

(57) ABSTRACT

A method, system, and non-transitory computer-readable storage medium for migrating connectivity signals of a gaming computer network in a gaming environment. The computer network includes multiple hosts and wireless peripheral devices, each host having a respective wired connection to the electronic gaming device, each peripheral device wirelessly connected to the electronic gaming device. The hosts are configured to maintain connectivity between the peripheral devices and the electronic gaming device. The approach includes determining status information of the computer network and receiving, from at least one wireless peripheral device, signals including feature data. The approach includes determining, based on the status information and the signals, a migration of connectivity signals for maintaining connection of a wireless peripheral device to the electronic gaming device, from the first host to a second host different from the first host. The approach includes migrating the connectivity signals from the first host to the second host.

### TECHNICAL FIELD

This disclosure relates generally to the management of multiple hosts with predictive and seamless host migration in a gaming environment.

### BACKGROUND

A gaming environment can be a complex ecosystem with different types of connected devices to a console, including a wide variety of computing devices and peripheral devices, to enhance user experience and interactivity with games. Modern gaming systems often include opportunities to integrate multiple peripherals, for example, virtual reality headsets, motion-sensing controllers, headphones/earbuds, and others that provide immersive gameplay.

### SUMMARY

This specification describes a method, system, and non-transitory, computer-readable medium for managing multiple hosts in a gaming computer network for a gaming environment. The gaming computer network includes an electronic gaming device for performing software applications such as gaming, streaming, and communication with other players. The gaming computer network also includes multiple hosts, each including a respective wired connection to the electronic gaming device and configured by the electronic gaming device to maintain and/or improve connectivity in the gaming computer network. The gaming computer network also includes one or more wireless peripheral devices that communicate wirelessly with the electronic gaming device. The disclosed technology is directed to the migration of connectivity signals for wirelessly connecting the wireless peripherals to the electronic gaming device, by migrating the connectivity signals from one host to another.

The techniques disclosed here include determining status information of the gaming computer network and receiving, from at least one wireless peripheral device, signals that include feature data of the gaming environment. Examples of feature data can include data relating to a configuration of a device such as a host, wireless peripheral device, etc., data related to physical actions by the player, e.g., movement or lack thereof, data related to user input provided by the player to the electronic gaming device via the wireless peripheral device, and other types of metrics relating to gameplay of the electronic gaming device. The techniques described herein can be applied to different types of electronic gaming devices (“gaming devices”), such as console devices (“consoles”), mobile devices, personal computers (e.g., laptops, desktops), and other types of devices configured for video gaming.

The electronic gaming device can be configured to determine a migration of connectivity signals from a first host to a second host in the gaming computer network based on the status information of the gaming computer network and the feature data from the signals. Determining a migration of connectivity signals between hosts can include identifying a migration of signals from one host to another host that can maintain and/or improve connectivity of peripheral devices to the electronic gaming device, e.g., to reduce latency, increase bandwidth of the electronic gaming device, and improve network traffic in a gaming computer environment. A migration of connectivity signals can include transitioning computing processes between hosts, in which the computing processes are processes that would otherwise be performed, e.g., by the electronic gaming device, to provide and/or maintain connectivity between peripheral devices and the electronic gaming device. In this way, the disclosed technology can provide seamless integration of wireless and wired devices in a gaming computer environment, low latency, reduced packet loss rates, and high responsiveness, to cater to the growing demand for realistic and engaging gaming environments.

The disclosed technology can utilize feature data of the gaming environment to identify opportunities to migrate hosts, identify which hosts to migrate connectivity signals to, and perform the migration of connectivity signals from one host to another. In some instances, the feature data can also include network and performance parameters related a device in the gaming computer network, including latency, ping, battery level, battery capacity, frame rate, and computation load.

The disclosed technology can utilize predictive models trained to identify migrations of computer functions between hosts based on the feature data from signals of wireless peripheral devices in the computer network. In this way, the predictive models provide the electronic gaming device an opportunity to prevent the computer network exceeding a threshold amount of latency, packet data loss, bandwidth consumption, etc. The predictive models can be trained to identify particular migrations of operations (such as software applications, computing processes and functions) that would otherwise be performed by the electronic gaming device, among the hosts. Each host can include a respective antenna and the predictive models can be trained to determine a set of antenna parameters to achieve a seamless (e.g., little to no lag) migration of computing operations among the hosts. The disclosed technology can allow the host of the electronic gaming device to generate adjustments of antenna parameters that account for the status, signals, and parameters of devices in the gaming computer network, including the hosts, wireless peripherals, and the electronic gaming device itself.

In general, one innovative aspect of the subject matter described in this specification can be embodied in methods performed by an electronic gaming device in a gaming environment. The method includes determining status information of a gaming computer network in the gaming environment. The gaming computer network includes multiple hosts and one or more wireless peripheral devices in the gaming environment, each of the multiple hosts having a respective wired connection to the electronic gaming device, each of the one or more wireless peripheral devices wirelessly connected to the electronic gaming device. The multiple hosts are configured to maintain connectivity between the one or more wireless peripheral devices and the electronic gaming device. The methods include receiving, from at least one wireless peripheral device from the one or more wireless peripheral devices, signals including feature data of the gaming environment. The methods include determining, based on the status information and the signals, a migration from a first host in the multiple hosts to a second host in the multiple hosts different from the first host. Migrating from the first host to the second host includes migrating connectivity signals for maintaining connection of a first wireless peripheral device from the one or more wireless peripheral devices to the electronic gaming device from the first host to the second host. The methods include migrating the connectivity signals for maintaining connection of the first wireless peripheral device to the electronic gaming device from the first host to the second host.

Other embodiments of this aspect include corresponding computer systems, apparatus, and computer programs recorded on one or more computer storage devices, each configured to perform the actions of the methods.

The foregoing and other embodiments can each optionally include one or more of the following features, alone or in combination. In particular, one embodiment includes all the following features in combination. In some implementations, determining the migration based on the status information and the signals includes determining that a parameter relating to connectivity between the first wireless peripheral device and the electronic gaming device exceeds a threshold value. In some implementations, the parameter is one of (i) latency, (ii) bandwidth utilization, or (iii) packet loss rate.

In some implementations, the method includes detecting, based on the feature data from the signals, a change in the status information of the gaming computer network in the gaming environment.

In some implementations, the electronic gaming device includes a first antenna, and each of the multiple hosts includes a respective antenna.

In some implementations, migrating the connectivity signals for maintaining connection of the first wireless peripheral device to the electronic gaming device from the first host to the second host includes switching communication of signals from a first frequency channel in multiple frequency channels to a second frequency channel in the multiple frequency channels. The second frequency channel different from the first frequency channel.

In some implementations, the method includes transmitting, by the first antenna of the electronic gaming device, a waveform for monitoring a parameter representing connectivity of one or both of (i) a particular host from the multiple hosts, or (ii) a particular wireless peripheral device from the one or more wireless peripheral devices, of the gaming computer network. In some implementations, the method includes receiving, by the electronic gaming device, a waveform response including data indicating the status information for the one or both of (i) the particular host or (ii) the particular wireless peripheral device.

In some implementations, the at least one wireless peripheral device is configured to: capture the feature data of the gaming environment; generate the signals representing the feature data; and transmit the signals to the electronic gaming device.

In some implementations, the at least one wireless peripheral device is configured to capture physical input data of an input from a user in the gaming environment. In some implementations, the at least one wireless peripheral device is configured to capture positional data of a user in the gaming environment. In some implementations, the at least one wireless peripheral device is configured to capture audio data of a user in the gaming environment.

In general, another innovative aspect of the subject matter described in this specification can be embodied in a system for a gaming environment including an electronic gaming device configured to determine status information of a gaming computer network in the gaming environment. The gaming computer network includes multiple hosts and one or more wireless peripheral devices in the gaming environment, each of the multiple hosts having a respective wired connection to the electronic gaming device, each of the one or more wireless peripheral devices wirelessly connected to the electronic gaming device, and the multiple hosts are configured to maintain connectivity between the one or more wireless peripheral devices and the electronic gaming device. The electronic gaming device is configured to receive, from at least one wireless peripheral device from the one or more wireless peripheral devices, signals including feature data of the gaming environment. The electronic gaming device is configured to determine, based on the status information and the signals, a migration from a first host in the multiple hosts to a second host in the multiple hosts different from the first host. Migrating from the first host to the second host includes migrating connectivity signals for maintaining connection of a first wireless peripheral device from the one or more wireless peripheral devices to the electronic gaming device from the first host to the second host. The electronic gaming device is configured to migrate the connectivity signals for maintaining connection of the first wireless peripheral device to the electronic gaming device from the first host to the second host.

The foregoing and other embodiments can each optionally include one or more of the following features, alone or in combination. In particular, one embodiment includes all the following features in combination.

In some implementations, determining the migration based on the status information and the signals includes determining that a parameter relating to connectivity between the first wireless peripheral device and the electronic gaming device exceeds a threshold value. In some implementations, the parameter is one of (i) latency, (ii) bandwidth utilization, or (iii) packet loss rate.

In some implementations, the electronic gaming device is configured to detect, based on the feature data from the signals, a change in the status information of the gaming computer network in the gaming environment.

In some implementations, the electronic gaming device includes a first antenna, and each of the multiple hosts includes a respective antenna.

In some implementations, migrating the connectivity signals for maintaining connection of the first wireless peripheral device to the electronic gaming device from the first host to the second host includes switching communication of signals from a first frequency channel in multiple frequency channels to a second frequency channel in the multiple frequency channels. The second frequency channel different from the first frequency channel.

In some implementations, the electronic gaming device transmits, by the first antenna of the electronic gaming device, a waveform for monitoring a parameter representing connectivity of one or both of (i) a particular host from the multiple hosts, or (ii) a particular wireless peripheral device from the one or more wireless peripheral devices, of the gaming computer network. In some implementations, the electronic gaming device is configured to receive a waveform response including data indicating the status information for the one or both of (i) the particular host or (ii) the particular wireless peripheral device.

In some implementations, the at least one wireless peripheral device is configured to: capture the feature data of the gaming environment; generate the signals representing the feature data; and transmit the signals to the electronic gaming device.

In some implementations, the at least one wireless peripheral device is configured to capture physical input data of an input from a user in the gaming environment. In some implementations, the at least one wireless peripheral device is configured to capture positional data of a user in the gaming environment. In some implementations, the at least one wireless peripheral device is configured to capture audio data of a user in the gaming environment.

In general, another innovative aspect of the subject matter described in this specification can be embodied in A non-transitory computer-readable storage device storing instructions that when executed by one or more processors of an electronic gaming device cause the one or more processors to perform operations. The operations include determining status information of a gaming computer network in a gaming environment, the gaming computer network including multiple hosts and one or more wireless peripheral devices in the gaming environment, each of the multiple hosts comprising a respective wired connection to the electronic gaming device, each of the one or more wireless peripheral devices wirelessly connected to the electronic gaming device. The multiple hosts are configured to maintain connectivity between the one or more wireless peripheral devices and the electronic gaming device. The operations include receiving, from at least one wireless peripheral device from the one or more wireless peripheral devices, signals including feature data of the gaming environment. The operations include determining, based on the status information and the signals, a migration from a first host in the multiple hosts to a second host in the multiple hosts different from the first host. Migrating from the first host to the second host includes migrating connectivity signals for maintaining connection of a first wireless peripheral device from the one or more wireless peripheral devices to the electronic gaming device from the first host to the second host. The operations include migrating the connectivity signals for maintaining connection of the first wireless peripheral device to the electronic gaming device from the first host to the second host.

The foregoing and other embodiments can each optionally include one or more of the following features, alone or in combination. In particular, one embodiment includes all the following features in combination.

In some implementations, determining the migration based on the status information and the signals includes determining that a parameter relating to connectivity between the first wireless peripheral device and the electronic gaming device exceeds a threshold value. In some implementations, the parameter is one of (i) latency, (ii) bandwidth utilization, or (iii) packet loss rate.

In some implementations, the operations include detecting, based on the feature data from the signals, a change in the status information of the gaming computer network in the gaming environment.

In some implementations, the electronic gaming device includes a first antenna, and each of the multiple hosts includes a respective antenna.

In some implementations, migrating the connectivity signals for maintaining connection of the first wireless peripheral device to the electronic gaming device from the first host to the second host includes switching communication of signals from a first frequency channel in multiple frequency channels to a second frequency channel in the multiple frequency channels. The second frequency channel different from the first frequency channel.

In some implementations, the operations include transmitting, by the first antenna of the electronic gaming device, a waveform for monitoring a parameter representing connectivity of one or both of (i) a particular host from the multiple hosts, or (ii) a particular wireless peripheral device from the one or more wireless peripheral devices, of the gaming computer network. In some implementations, the operations include receiving, by the electronic gaming device, a waveform response including data indicating the status information for the one or both of (i) the particular host or (ii) the particular wireless peripheral device.

In some implementations, the at least one wireless peripheral device is configured to: capture the feature data of the gaming environment; generate the signals representing the feature data; and transmit the signals to the electronic gaming device.

In some implementations, the at least one wireless peripheral device is configured to capture physical input data of an input from a user in the gaming environment. In some implementations, the at least one wireless peripheral device is configured to capture positional data of a user in the gaming environment. In some implementations, the at least one wireless peripheral device is configured to capture audio data of a user in the gaming environment.

The technology described in this specification can be implemented to realize one or more of the following advantages. The disclosed technology can provide dynamic management and seamless migration of connectivity signals from one host to another in the gaming computer environment, to reduce latency, packet data loss, and other types of signal loss between the wireless peripheral and the electronic gaming device. By leveraging predictive techniques for migrating connectivity signals for hosts and the electronic gaming device in the gaming computer network, each host can be more efficiently configured to perform functions for the wireless devices by reducing network delays, compared to approaches without predictive host migrations. These functions can include, but are not limited to, maintaining connectivity between the wireless peripherals and the electronic gaming device, pre-processing data for the electronic gaming device, managing game state in a gaming software application, handling data exchange between the peripheral devices and the electronic gaming device, reducing latency and lag between devices, storing data, event logging, and managing signals for communication (audio, video, text).

For example, the electronic gaming device can migrate connectivity signals for the peripheral device from one host to another to maintain or improve connectivity between the electronic gaming device and the peripheral device when the location of the peripheral device changes. For instance, the electronic gaming device can migrate the wireless connectivity signal between hosts in different locations when the peripheral device moves closer to one host than the other. A wired connection between the hosts and the electronic gaming device can ensure a higher quality connection (e.g., low latency, faster data transmission rate), compared to a wireless connection with the wireless peripheral. In this way, the gaming network can achieve the benefit of mobility and convenience associated with wireless peripherals with higher data quality/rates and lower interference/latency typically associated with wired communication. In particular, the electronic gaming device can itself include a host and leverage locations of other hosts in the gaming environment with respect to locations and connectivity to wireless peripherals. The electronic gaming device can then take advantage of a reduced signal interference and improved line-of-sight accessibility between the host and the other peripheral devices to achieve an improved (e.g., highest-quality available) data link to wireless peripherals in the gaming ecosystem, e.g., compared to the other available links.

Other advantages can include reduced interference in a gaming computer network, such as reducing the interference experienced by one or more hosts and/or the electronic gaming device. For context, devices in a gaming computer network can transmit signals but obstructions or other types of objects in a gaming environment can inadvertently cause interference, e.g., reflecting or refracting signals away from a device that is expected to receive one or more signals. In some cases, the dense number of devices and different types of devices in the gaming computer network for a gaming environment can also generate interference with higher power consumption and latency, with lower available bandwidth. The disclosed technology provides that a particular host can, in certain implementations, be used in close proximity to a player and other wireless peripheral devices in the gaming environment to reduce or mitigate the effects of interference. As such, wireless communication for the wireless peripherals can be hosted by the host that is nearest to the player and the wireless peripheral, and communicated through the wired connection of the closest host that connects to the electronic gaming device. Such an arrangement can reduce interference due to physical obstructions or other interfering signals.

Another advantage of the disclosed technology can include improved directionality, signal transmission, and signal receipt by antennas included in the hosts. For example, by understanding the relative orientations of the wireless peripheral devices with respect to a host or multiple hosts in the gaming computer network, the disclosed technology can determine an adjustment to the antenna parameters, e.g., directionality for beamforming, thereby improving the performance of said antennas. Determination for migrating connectivity signals to a host can be based on target parameters, such as size, orientation, power configuration, etc., of the antennas, to maintain at least a threshold stability of a wireless communication link between the wireless peripheral and the electronic gaming device.

In another example, the disclosed technology can improve computational efficiency of the electronic gaming device and increase available bandwidth for the electronic gaming device to perform any type of software application. Migrating the connectivity signals from one host to another can relieve the electronic gaming device from computational burdens and save computational resources like bandwidth and electrical power that would otherwise be consumed by a wireless connection. In this way, the electronic gaming device can distribute computational loads across a wired network of hosts to provide distributed computer processing in the gaming environment and can maintain a reserve of computing bandwidth for additional computing performance for software applications like streaming and communicating with other players.

In some instances, rather than using a single, built-in wireless adapter, an electronic gaming device can select from multiple communication channels through which to communicate with the wireless peripheral devices in the gaming environment. For example, an electronic gaming device can route some of the data communication through a first host that may be closer to a particular wireless peripheral device, e.g., closer to the player, and/or may have a less obstructed view of the particular wireless peripheral than the electronic gaming device itself. Routing a portion of data communication between the host and one or more wireless peripheral devices can reduce power requirements for the data transmission by leveraging the decreased distance, reduced physical obstructions, and decreased interference from one or more other wireless data communication channels from the host.

In particular, the electronic gaming device can prioritize data communication traffic through a wired data communication channel from a host closest to one or more wireless peripheral devices, such that all downstream communication for the one or more wireless peripheral devices are operating at least a threshold performance. For example, threshold performance can include the performance of native operations for the host in the gaming computer network and the performance of the native operations of each wireless peripheral device.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is a diagram of an example management and migration of multiple hosts in a gaming computer network for a gaming environment.

FIG. 1B is a diagram of an example gaming environment for managing and migration multiple hosts in a gaming computer network for a gaming environment.

FIG. 2 is a block diagram of a gaming computer network for managing multiple hosts in a gaming environment.

FIG. 3 is a flow diagram of an example process for host management and migration.

FIG. 4 is an example computer device for host management and migration.

Like reference numbers and designations in the various drawings indicate like elements.

### DETAILED DESCRIPTION

A gaming environment (also referred to as a “gaming ecosystem”) generally includes devices used in a gaming session by one or more users, also referred to as “players.” A gaming ecosystem includes a gaming computer network connecting multiple types of electronic gaming devices, such as console devices, computers, peripheral devices, and other types of computer hardware to support a gaming session. Gaming sessions can involve the simultaneous use of multiple types of these devices, and different scenarios occurring during a session can present challenges in maintaining connectivity between devices in the gaming computer network. As an example, the complex and dense nature of computer networks for gaming ecosystems can result in poor connectivity, high latency, data packet dropping, and other types of computer-operability problems in the gaming computer network. These types of technical computer-problems in the gaming computer network can drastically reduce the quality of a gaming session for the player due to the poor connectivity, as well as increase the extraneous consumption of computing resources (such as bandwidth and electrical power) to maintain a connection for the electronic gaming device in the gaming computer network.

An electronic gaming device can run (e.g., execute) different software applications to allow players to play video games, stream video of gameplay footage, provide audio/video communication to other electronic gaming devices, perform other types of software applications for gaming. A gaming environment also includes multiple peripheral devices wirelessly connected to the electronic gaming device to collect input from the player to the electronic gaming device, provide feedback from the electronic gaming device to the player, and enhance the player's gaming experience. While wireless peripheral devices allow players to have greater mobility and flexibility, improve ergonomics, and take up less space due to the lack of cables, the wireless nature of the peripheral devices introduce a variety of issues in the gaming computer network, such as signal interference, data packet loss, increased latency, among others. The wireless peripheral devices also generally rely on mobile batteries that demand re-charging to avoid inoperability and/or operational downtime, compared to wired connections that can maintain a direct power connection and have improved or increased operability by comparison. The proliferation of wireless peripheral devices in gaming environments has also introduced different scenarios that degrade connectivity in the environment, e.g., from the increased computational demand, latency, and signal drop-off associated with the increased range of the wireless peripherals.

To support the operability of software applications by the electronic gaming device, the gaming computer network can include host devices (also referred to as “hosts”) that include a wired connection to the electronic gaming device. A wired connection between the hosts and the electronic gaming device can improve communication between the host and the electronic gaming device with higher data quality (e.g., low latency, faster data transmission rate) compared to a wireless connection. In particular, hosts can be configured by the electronic gaming device to perform tasks that allow or support connectivity between a peripheral device and the electronic gaming device. Examples of tasks include managing game state (e.g., state of the video game a current time), handling data exchange between the peripheral devices and the electronic gaming device, reducing latency and lag between devices, storing data, event logging of events by the player and/or devices, and managing in-game communication (audio, video, text). Thus, there is a demand for a framework for seamless management and migration of functions and related computer processes between the hosts in the gaming computer network to support the electronic gaming device in performing the tasks in the gaming environment.

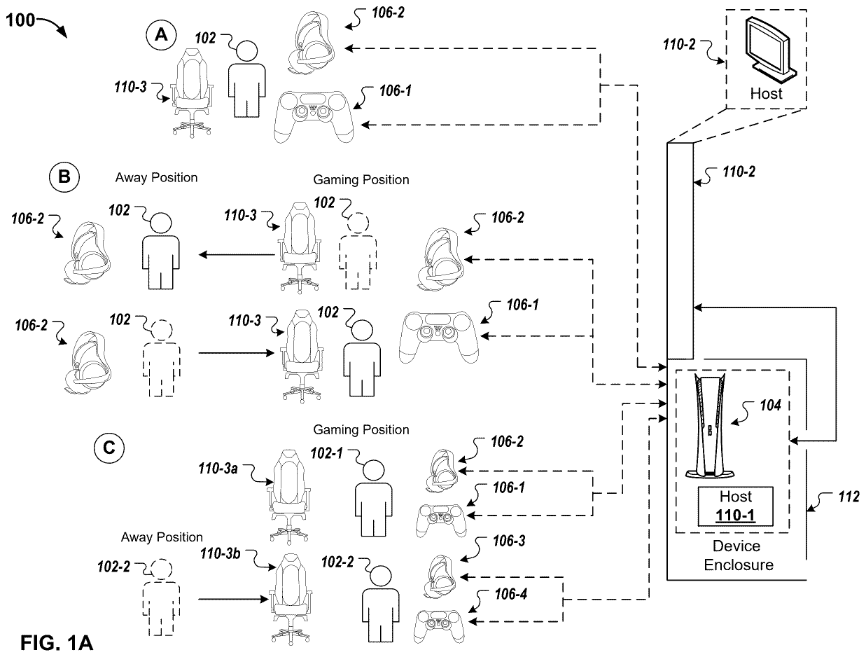

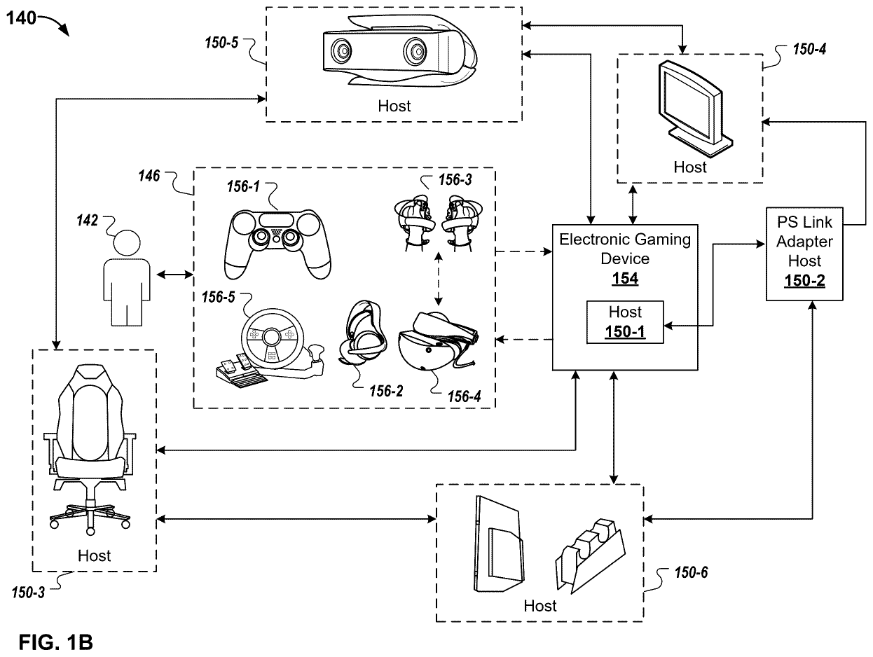

FIG. 1A is a diagram of an example management and migration of multiple hosts in a gaming computer network for a gaming environment 100. FIG. 1A depicts three example scenarios, indicated by letters “A,” “B,” and “C,” in the diagram in which the gamer interacts with the devices in the environment in different combinations and in different locations. These scenarios depict different states that may occur in a single, continuous gaming session. Scenario A shows a player 102 in a gaming computer network that includes wireless peripheral devices 106-1 and 106-2 (collectively referred to as “wireless peripherals 106”) connected to an electronic gaming device 104. The electronic gaming device 104 (also referred to as “gaming device 104”) can include a gaming device host 110-1 (also referred to as a “device host 110-1”) for a gaming session for the player 102 in the gaming environment 100. Although FIG. 1A depicts the gaming device 104 as a single gaming device, the gaming device 104 can be any number of gaming consoles, computers, devices, etc. Furthermore, the gaming device 104 can also be a mobile gaming device, such as a mobile device, a personal computer, such as a laptop or personal computer, or any other type of device for video gaming.

In addition to the device host 110-1, scenario A in the gaming environment 100 also includes a host 110-2 depicted as a display device (e.g., monitor, screen) and a host 110-3 depicted as a gaming chair. Both host 110-2 and host 110-3 include a respective wired connection to the device host 110-1. The device host 110-1, host 110-2, and host 110-3 can collectively be referred to as “hosts 110.” Each of the hosts can include a respective antenna that allows for wireless communication with the wireless peripheral devices. The antenna of the host can be configurated to communicate using radio frequency (RF) signals. A host in a gaming environment can include hardware and software to allow enable near-field communication for the host and any peripheral devices. A host can be configured to apply the techniques disclosed herein to achieve improve authenticity, security, and trust between peripherals and the electronic gaming device (such as a console device, a mobile phone, laptop, personal computer, or any type of gaming device).

FIG. 1A also depicts wireless peripheral device 106-1 as a gaming headset and wireless peripheral device 106-2 as a gaming controller. The player 102 can play a video game in a gaming session using the gaming device 104, by providing a user input to the wireless peripheral devices 106-1 and 106-2 connected to the gaming device 104. The wireless peripheral devices 106-1 and 106-2 provides the user input to the gaming device 104, which processes the user input for gameplay.

The gaming device 104 can process the user input, perform a corresponding action in a gaming software application, and update a display device of the gaming device 104 to demonstrate the performance of the corresponding action, among other types of software applications. For example, the player 102 can press buttons of the wireless peripheral device 106-1 to perform in a user interface or gaming application of the gaming device 104, e.g., navigating a menu, moving a character in a video game. As another example, the player 102 can provide a voice input to the wireless peripheral device 106-2 for transmission to the gaming device 104. One example of a voice input can be a command for a gaming application of the gaming device 104, but another example can include communication with another player in a different gaming environment with a different gaming device, e.g., computer, console, handheld gaming device.

Referring to the hosts 110, the device host 110-1 can be configured to transition operations for communication, gaming, storage, etc., between the hosts to reduce latency and other types of signal degradation. Rather than communicate data for a user input (e.g., signals) by a wireless peripheral directly from the wireless peripheral to the device host 110-1, the device host 110-1 can configure a particular host that is closer in proximity to the wireless peripheral or has a strong connection to receive the data and then transmit the data through a wired connection between the particular host and the device host 110-1. In this way, one or both of the host 110-2 and host 110-3 can be configured by the device host 110-1 to receive and transmit data from a wireless peripheral with lower latency, loss, etc., compared to wirelessly transmitting the same data from the same wireless peripheral to the device host 110-1.

In some implementations, the device host 110-1 can configure another host in the gaming environment to perform pre-processing operations prior to transmitting data from a wireless peripheral to the gaming device 104. In this way, the device host 110-1 can distribute computational loads across a wired network of hosts to provide distributed computer processing in the gaming environment. By distributing the computational load across multiple hosts, the device host 110-1 can maintain a reserve of computing bandwidth for additional applications, thereby improving the efficiency of the gaming device 104. The increased bandwidth for the gaming device 104 allows for increased bandwidth by the gaming device 104 to perform additional applications. Increasing the bandwidth of the gaming device 104 improves the capability of the gaming device 104 to perform multiple instances and types of software applications simultaneously, such as gameplay, streaming on audio/video platforms, and audio/video communication with other players.

In general, the gaming device 104 is configured to communicate with the wireless peripheral devices in the gaming environment 100 through direct communication through wireless data communication channels. In some instances, a gaming environment 100 can include multiple wireless peripheral devices 106-1 to 106-N transmitting/receiving data with the gaming device 104 during a gaming experience of a user(s), where limitations of wireless data communication channels between the gaming device 104 and one or more wireless peripheral devices 106 can result in degradation of the gaming experience. For example, wireless data communication channels can be affected by distance between transmitter (Tx) and receiver (Rx), obstructions between Tx and Rx, and number of client wireless peripheral devices using the data communication channel to transmit/receive with the device host 110-1.

The gaming device 104 determines a status (e.g., status information) of the gaming computer network in the gaming environment 100. The gaming device 104 can determine status information of the hosts, e.g., 110-1, 110-2, and 110-3, and one or more wireless peripheral devices 106, e.g., 106-1 and 106-2. The gaming device 104 can be configured to receive signals that include feature data of the gaming environment from a wireless peripheral device, though in some implementations, the signals can include feature data from multiple wireless peripheral devices. The gaming device 104 can be configured to determine, based on the status information and/or the signals, that a migration of a first host to a second host can maintain or improve connectivity between devices in the gaming computer network.

In particular, the gaming device 104 determines which host from the multiple hosts in the gaming environment can achieve improved connectivity for the wireless peripheral devices. For example, signals for connecting a first wireless peripheral can be migrated from a first wired host to a second wired host to maintain connectivity to the gaming device 104. In some implementations, the gaming device 104 determines a first subset of the connectivity signals can be migrated from a first host to a second, different host, and a second subset of the connectivity signals (different from the first subset) can be migrated to a third host different from the first and the second hosts. The gaming device 104, such as by the device host 110-1 and/or hardware processors and software of the gaming device 104, can migrate the connectivity signals to the respective hosts to maintain of the wireless peripheral device to the gaming device.

The feature data include information such as a current configuration of a device, such as a host or wireless peripheral device. Examples of feature data can include data related to physical actions by the player 102, such as movement from one area of the gaming environment to another area of the gaming environment. In some cases, the feature data can characterize a lack of physical action by the player 102. In another example, the feature data can include data related to and/or including the user input provided by the player 102 to a wireless peripheral device 106. For example, the feature data can include data related to engagement between the player and devices with the environment 100. In another example, the feature data can include data related to gameplay of the gaming device 104, such as performance, metrics, and actions. The feature data can also include network and performance parameters related to a host and/or the wireless peripheral device, including latency, ping, battery level, battery capacity, frame rate, and computation load.

In some implementations, the gaming device 104 can stored in a device enclosure 112 (“enclosure 112”) in the gaming environment, e.g., the gaming environment can optionally include the device enclosure 112. Examples of enclosures can include entertainment centers, shelves, television stands, cabinets. In some cases, the enclosure 112 may inadvertently result in increased latency and weaker communication between the gaming device 104 and the wireless peripherals 106, e.g., from the enclosure 112 blocking signal pathways between the gaming device 104 and other devices. In said cases, the disclosed techniques for host management and migration can mitigate adverse effects from storing the gaming device 104 in the enclosure 112. As depicted in FIG. 1A, the enclosure 112 may include one or more openings to allow a wired connection between the gaming device 104 and another device, such as a host. In some implementations, the gaming device 104 may be arranged in a way that inadvertently increases latency or other types of delay between the gaming device 104 and wirelessly connected devices, by arranging the gaming device 104 in a way that orients its antenna for communication in a direction away (rather than towards) any wireless connected devices.

Referring to Scenario B of FIG. 1A, the gaming environment 100 shows the player 102 in a first position relatively close to the gaming device 104, indicated in FIG. 1A as a “gaming position” in the gaming environment 100. In scenario B, the player 102 may interact with the gaming device 104 using the wireless peripheral controller 106-1 and the wireless peripheral headset 106-2. In the gaming position, connectivity signals for the wireless peripheral controller 106-1 and the wireless peripheral headset 106-2 may be managed and hosted by the device host 110-1 of the gaming device 104. The player 102 may leave from the gaming position to a second, different position in the gaming environment, indicated in FIG. 1A as an “away position” in the gaming environment 100, and can move to multiple different positions. The gaming device 104 can detect a status of the environment, such as the player and any associated wireless peripheral devices having a different or changing position relative to the gaming device 104, so that the connectivity signals for the associated wireless peripheral devices can be transitioned from one host to another host, e.g., to maintain connectivity, reduce latency/lag compared to maintaining the connection directly with the device host.

In scenario B, the player 102 can leave the wireless peripheral controller 106-1 at the gaming position and continue wearing the wireless peripheral headset 106-2 when moving to the away position. The connectivity signals for connecting wireless peripherals that remain in proximity to the device host 110-1 of the gaming device 104 can be managed and hosted by the device host 110-1. For example, connectivity signals for the wireless peripheral controller 106-1 can be maintained by the device host 110-1 of the gaming device 104. In contrast, connectivity signals for wireless peripherals that are outside a threshold distance from the device host 110-1, e.g., outside the proximity of the gaming device 104, can be transitioned to another hosts. For example, the player 102 can wear the wireless peripheral headset 106-2 when transitioning between positions and connectivity signals for the wireless peripheral headset 106-2 can be migrated to a host different than the device host 110-1 of the gaming device. In particular, a host closer to the wireless peripheral headset 106-2 in the away position can be the gaming chair depicted in scenario B, e.g., host 110-3.

As the player transitions from the away position back to the gaming position, the connectivity signals can be migrated back to the device host 110-1. This is particularly useful in example scenarios where the player 102 can play a game in the gaming position using the wireless peripheral controller 106-1, while communicating with other players via audio transmission using the wireless peripheral headset 106-2. Both wireless peripheral devices (headset, controller) can have connectivity signals hosted by the device host 110-1 of the gaming device 104. The player 102 may pause gameplay in the gaming position, take a break between rounds, or being moving to the away position, leaving the wireless peripheral controller 106-1 in the gaming position (thus no longer providing input). While the player 102 may leave the wireless controller in the gaming position, the player 102 can continue speaking with other players using the wireless peripheral headset 106-2 when transitioning to the away position or at the away position, e.g., continue wearing and speaking into the wireless peripheral headset 106-2. In this way, latency between the wireless peripheral headset 106-2 and the device host 110-1 can be reduced by migrating connectivity signals for the wireless peripheral headset 106-2 to a host closer to the away position, e.g., host 110-3. When the player transitions back from the away position to the gaming position, the connectivity signals can be migrated back to the device host 110-1 from the host 110-3.

In scenario C, the player 102 is a first player in the gaming environment 100 and is indicated in the gaming environment 100 as player 102-1. Player 102-1 can play a game on the gaming device 104 using wireless peripheral controller 106-1 and the wireless peripheral headset 106-2 at the gaming position. In contrast to scenario B, the gaming environment 100 includes a second set of peripherals for a second player to join the gameplay on the gaming device 104. For example, the gaming environment 100 includes a second wireless peripheral controller 106-4 and a second wireless peripheral headset 106-3 at the gaming position. A second player 102-2 can be at an away position and can move to the gaming position to join the gameplay on the gaming device 104. Upon the player 102-2 putting on the second wireless peripheral headset 106-3 and/or picking up the second wireless peripheral controller 106-4, the gaming device 104 can determine a change in the status information for the gaming environment 100, e.g., a second player joined or is going to join the gaming session.

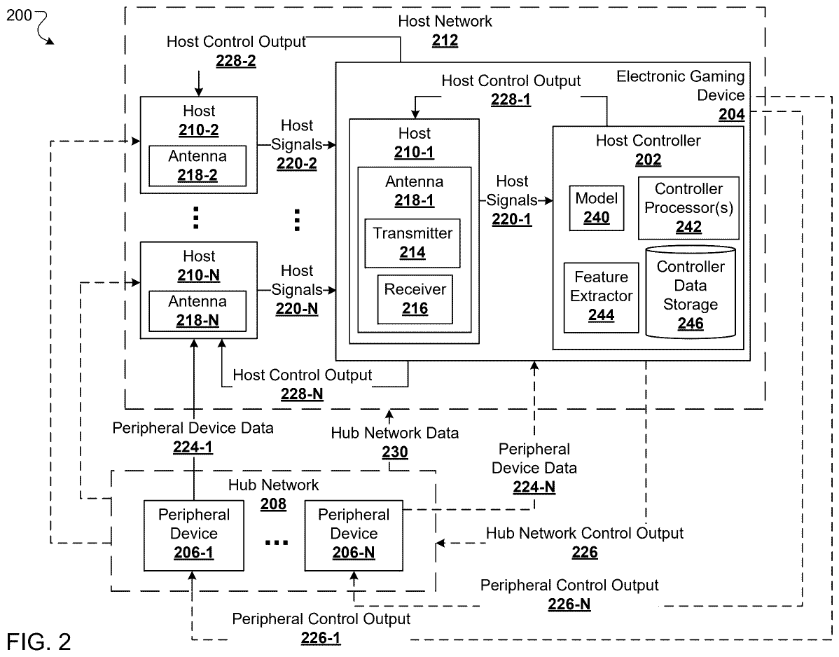

The gaming device 104 can transition connectivity signals across different hosts from multiple hosts in the gaming environment, based on the second player 102-2 joining the gaming session. For example, the gaming device 104 can transition connectivity signals for wireless peripherals (e.g., wireless peripheral controller 106-1 and wireless peripheral headset 106-2) associated with the first player 102-1 to a second host different than the device host 110-1, e.g., a display device including a host 110-2 (also referred to as “display host 110-2”). The gaming device 104 can transition connectivity signals for wireless peripherals (e.g., wireless peripheral controller 106-4 and wireless peripheral headset 106-3) associated with the second player 102-1 to a third host different than the device host 110-1 and the display host, e.g., a gaming chair host 110-3b depicted in FIG. 1A. In some implementations, the gaming device 104 (e.g., by the device host 110-1) can also migrate connectivity signals for the first player 102-1 to a gaming chair host 110-3a depicted in FIG. 1A, e.g., instead of or in addition to migrating to display host 110-2. In some cases, the gaming device 104 (e.g., by the device host 110 and/or by hardware processors and data storage storing instructions for the gaming device 104 as described in reference to FIG. 2 below) can migrate connectivity signals for a wireless peripheral based on a type of the peripheral. For example, connectivity signals for wireless headsets for both players 102-1 and 102-2 can be migrated to a display host 110-2. Connectivity signals for wireless controllers for both players 102-1 and 102-2 can be maintained by the device host 110-1 or can be migrated to another host for managing wireless controller connectivity, e.g., gaming chair hosts 110-3a and 110-3b.

Although FIG. 1A depicts scenarios A, B, and C for host management and migration, examples of host management and migration can be applied to other types of scenarios. Example scenarios can include a particular type of gameplay occuring by the gaming device 104 in the gaming environment. The signals from the wireless peripherals can be used to capture feature data of the game state of the game being played using the gaming device 104, as well as other features of the gaming environment prior to, during, and after gameplay.

As an example, a cutscene can be played on a display device and the gaming device 104 can be configured to maintain connectivity and reduce latency of audio signals to the wireless headset for the player. In some cases, certain types of user input by a wireless controller may not be processed on purpose (e.g., moving a character, performing an attack) during the cutscene, whereas some types of user input by the wireless controller can be processed during the cutscene, e.g., pause the cutscene, skip the cutscene. In this example, signals for the maintaining connectivity with the wireless controller can be assigned a lower priority than signals for providing connectivity to the headset to provide the audio for the scene, as well as signals to a device for display the cutscene.

As another example scenario, some types of games can allow for different types of peripherals that provide the same type of user input. For example, a racing game can be played using a wireless peripheral controller but can also be played using a wireless steering wheel and pedal set-up. The the gaming device 104 can determine that although multiple wireless peripherals capable of the same user input type are available, only the connectivity signals for a single instance of the user input type demand connectivity with the gaming device 104 to allow for gameplay. In some cases, any signals from a wireless peripheral can be assigned by a priority from the gaming device 104 to indicate a lower priority than another wireless peripheral currently in use by the player.

As another example scenario, signal connectivity and network traffic distribution can be achieved using multiple hosts based on the types of software applications performed by the gaming device 104. For example, a player 102 may be playing a game using a first software application of the gaming device, streaming video footage of said gameplay using a second software application and communicate with viewers or other streamers/players using a third software application. The gaming device 104 can prioritize, assign, and migrate connectivity of signals from wireless peripherals associated each of the software applications based on resource consumption and bandwidth availability. For example, the gaming device 104 can determine a processing load associated with a streaming software application and configured a host to manage connectivity of wireless peripherals associated with the streaming software application to said host. The gaming device 104 can determine a target host for each different instance and/or type of software application based on the computational demand of the software application and the available bandwidth of the respective target host.

The gaming device 104 can include hardware processors, such as one or more central processing units (CPU) and one or more graphics processing units (GPU) in data communication with memory. The hardware processors for the gaming device 104 can include input/output interfaces configurable to connect to one or other devices, such as the hosts 110-2 and 110-3 and the wireless peripheral devices 106-1 and 106-2. The gaming device 104 can be configured for data communication with one or more servers, e.g., cloud-based servers, through one or more wired or wireless communication networks, such as a cellular communication network, local area network (LAN), wide area network (WAN) such as the Internet, wireless LAN (WLAN), or other type of communication network.

The wireless peripheral devices 106 can generally be devices which facilitate interaction between the player 102 and the gaming device 104, among other devices in the gaming environment 100. The wireless peripheral devices 106 can be configurable to connect through respective data communication channels to the gaming device 104. The data communication channels can be wireless data communication channels, e.g., also referred to as “wireless data communication links.” In some implementations, peripheral devices can be configurable to connect to one or more other peripheral devices through respective data communication channels. Wireless data communication channels can be, for example, using Bluetooth, Wi-Fi, Zigbee, infrared, or another wireless communication protocol. Other examples of wireless peripheral devices 106 can include, for example, audio peripherals such as speakers, headphones, headsets, microphones, earbuds, and the like. Wireless peripheral devices 106 can include, for example, game controllers such as gaming racing wheels and pedals, flight simulator controls, joysticks, handheld controllers, and the like. Other examples of wireless peripheral devices can include computing peripherals such as keyboards, mice, and the like. Examples can also include virtual reality (VR) and augmented reality (AR) components such as VR headsets, goggles, handheld controllers, gloves, smart environments, wearable devices, and the like. Wireless peripheral devices can include image and video capture devices, such as web cameras, motion capture sensors, and the like.

Wireless peripheral devices 106 can include external data storage, for example, external hard drives, memory cards, memory card readers, and the like. Peripheral devices can include wireless communication hubs, for example, wireless network hubs, mesh network components, and the like. In some cases, wireless peripheral devices can include music and rhythm peripherals, for example, interactive musical instruments, microphones, dance interactive components, and the like. Wireless peripheral devices can include hybrid devices, for example, handheld controllers including a display device.

Although FIG. 1A depicts the display host 110-2 as a display device, the gaming environment 100 can include any kind of display device. Examples of displays include, a monitor, television, projector, or otherwise. The display host 110-2 can be configured for data communication with the gaming device 104 and relay audio/visual information from the gaming device 104. In some implementations, the gaming device 104 can be in data communication with two or more displays, for example, a monitor and a projected display by a projector onto a screen. Displays can be configured to receive and transmit information through a data communication channel to the electronic gaming device (also referred to as a “gaming system.” In some instances, the display is configured to receive input from a user, e.g., through a touch screen, by motion sensor/detector, or the like, and provide input to the gaming system. In some implementations, a display is an integrated component of a gaming device 104, for example, where the display is an integrated component within a form factor of the gaming system. In some implementations, the gaming environment 100 can include a display configured as a wireless peripheral device, rather than a wired host.

FIG. 1B is a diagram of an example gaming environment for managing and migration multiple hosts in a gaming computer network for a gaming environment. FIG. 1B shows a gaming environment 140 with an electronic gaming device 154 (similar to gaming device 104 of FIG. 1A) having a host 150-1 (similar to device host 110-1 of FIG. 1A). Similar to scenario A of FIG. 1A, the gaming environment 140 shows multiple hosts, collectively referred to as “hosts 150.” The hosts 150 include a first host 150-1 for the gaming device 154, a PS Link adapter host 150-2, a gaming chair host 154-3, a display host 154-4, a webcam host 150-5, and an auxiliary host 150-6. Each of the hosts 150-2 through 150-6 include a wired connection the gaming device 154. The gaming environment 140 also shows a player 142 interacting with the gaming device 154 using any number of wireless peripheral devices 156-1 through 156-N (collectively “wireless peripheral devices 156”).

Examples of the wireless peripheral devices can include a controller 156-1, headphones 156-2, VR handheld controllers 156-3, VR headset 156-4, and steering wheel and pedal controller 156-5. As described in reference to FIG. 1A, the wireless peripheral devices 156 allow the user to interact with the gaming device 154 for gameplay or another type of software application. For example, the wireless peripheral devices 156 can provide user input to the gaming device, such as to facilitate an action in a video game or provide/receive audio signals. In some cases, the gaming device 154 provides feedback signals to the player 142 through a wireless peripheral device, such as haptic feedback to generate vibrations, e.g., for the controller 156-1.

In some implementations, a wireless peripheral device can be referred to as a “hub” and multiple wireless peripheral devices connected to a same gaming device, e.g., gaming device 154, can be referred to as a “hub network” in the gaming environment. For example, FIG. 1B depicts a hub network 146 of wireless peripheral devices 156. A hub network 146 can be configured by the gaming device 154 to provide an integrated gaming environment into a single platform for gaming, entertainment, and social connectivity applications. The gaming device 154 can be configured to process signals including feature data from the multiple wireless peripherals in the hub network to generate control outputs for one or more connected hosts in the gaming environment.

FIG. 2 is a block diagram of a gaming computer network for managing multiple hosts in a gaming environment. The block diagram 200 shows a host network 212 that includes a host 210-1 of an electronic gaming device 204, similar to the host 110-1 of the gaming device 104 described in reference to FIG. 1A above. The gaming device 204 can include a host controller 202 configured to generate control outputs for managing and/or migrating hosts in a gaming computer network. The host network 212 also includes additional hosts 210-2 through 210-N that have wired connections to the gaming device 204. Each host from the hosts 210 includes a respective antenna configured for wireless communication with wireless peripheral devices in a gaming computer network. For example, the host 210-1 is depicted with an antenna 218-1 having a transmitter 214 for wirelessly transmitting data to wireless peripheral devices and a receiver 216 for wirelessly receiving data.

An antenna can be a near-field communication (NFC) antenna designed for short-range communication. For example, coil antennas, dipole antennas, path antennas, or the like. An antenna type can be selected for short-range communication operability. For example, dipole antenna, monopole antennas, path antennas, loop antennas, or the like. An antenna type can depend in part on a frequency of operation, e.g., a frequency band of the data communication. An antenna can be, for example, an omnidirectional antenna, e.g., a patch or microstrip antenna. The antenna can be a directional antenna, e.g., such as a Yagi antenna. Multiple design considerations of the antenna can be selected to yield a wireless data communication channel between the antenna and the one or more other peripheral devices that meets a threshold set of performance requirements, e.g., low latency, low loss, high reliability, and the like.

The design parameters can include, for example, size, placement, orientation, and power supply of the antenna. One or more of design parameters can be optimized to select an antenna type and configuration meeting at least a threshold set of performance requirements. Wireless transmission of data between the antenna of the host and the wireless peripheral devices can include signals representing feature data of the gaming environment. Although FIG. 2 depicts host 210-1 and host controller 202 as separate components of the gaming device 204, in some examples, host 210-1 and host controller 202 can part of the same component of the gaming device 204.

The diagram 200 shows each host 210-2 through 210-N having a respective antenna 218-2 through 218-N. Each host from the hosts 210 is also configured to transmit host signals 220-1 through 220-N (collectively “host signals 220”). The block diagram 200 also shows a hub network 208 of wireless peripheral devices 206-1 through 206-N, wireless connected to the one or more hosts from the host network 212. Each peripheral device 206 from the hub network 208 can be configured to transmit a respective set of peripheral device data 224. For example, peripheral device 206-1 can transmit signals as peripheral device data 224-1 to a host, e.g., host 210-N in the host network 212. Similarly, peripheral device 206-N transmits signals as peripheral device data 224-N to a host, e.g., host 210-1. Any of the peripheral devices 206-1 through 206-N can transmit signals, e.g., as peripheral device data 224, to any host 210 in the host network 212. In some implementations, signals for multiple datasets can be transmitted to the host network 212 as a single dataset as hub network data 230.

Referring to the gaming device 204, the host controller 202 includes a model 240, a controller hardware processor 242, controller data storage 246, and a feature extractor 244. The host controller 202 can process host signals from any of the hosts 210 and signals of feature data captured by any peripheral device 206 in the hub network 208. The host controller 202 can be configured to generate a control output for adjusting control of a host. For example, the host controller 202 can generate a host control output 228-1 for host 210-1, host control output 228-2 for host 210-2, and host control output 228-N for host 210-N. The control output for a host can indicate parameters for adjusting control of the antenna for the respective host, e.g., to migrate connectivity signals for one or more wireless peripherals from a first host to another, different host.

In some implementations, the hub controller 202 of the gaming device 204 can generate a hub network control output 226 for a hub network 208, e.g., a control output for at least a subset of the peripheral devices in the hub network 208. In some implementations, the host controller 202 can generate a peripheral control output for a corresponding peripheral device. For example, the host controller 202 can generate peripheral control output 226-1 for peripheral device 206-1 and a peripheral control output 226-N for peripheral device 206-N. The peripheral control output for a peripheral device can indicate a signal for wireless communication to the peripheral device, such as an audio signal, video signal, etc.

In some implementations, the host controller establishes multiple frequency channels between antennas of the hosts 210. The host controller 202 can determine a host control output to migrate connectivity signals to connect wireless peripherals through a host by switching from a first frequency channel to another, different frequency channel among the multiple frequency channels.

The host controller 202 can also be configured to generate a canary waveform for monitoring and tracking connectivity of wireless peripheral devices in a gaming computer network. In some cases, the canary waveform can be generated and used to monitor and tracking connectivity of at least a subset of hosts from the multiple hosts in the gaming computer network, e.g., between an electronic gaming device host and a host external to the electronic gaming device, between multiple external hosts and the electronic gaming device host, or between two or more hosts external to the electronic gaming device. One or both of the particular peripheral device(s) or the particular host(s) can be configured to generate a waveform response upon receiving the waveform. The waveform response can indicate information related to the particular peripheral device(s) or host(s) to provide to the host controller for processing, e.g., to generate a control output.

The host controller 202 includes the model 240 and the feature extractor 244 to process signals of feature data from the peripheral devices to determine status information of the gaming environment. The model 240 can generate a control output based on feature data and the feature extractor 244 can be configured to pre-process any received data, e.g., to generate feature vectors from signals. In this way, the host controller 202 can determine particular hosts to migrate connectivity signals for peripheral devices in a way that maintains wireless connection of the peripheral device to the gaming device 204. In some cases, the determination can be based on a migration of connectivity signals among hosts that improves latency, reduces packet loss rate, increases bandwidth of the gaming device 204, or some combination thereof. In some implementations, the model 240 can determine that a migration of connectivity signals from a first host to a second host can include an adjustment of parameters for each host, e.g., to facilitate the migration between the hosts.

The model 240 can be trained to generate control outputs that improve computational efficiency of the gaming computer network and its associated devices based on migrations of connectivity signals from one host to another. The parameters of the model 240 can be updated or adjusted based on a computational improvement for the gaming computer network. As an example, the model 240 can be trained to reduce an optimal migration or series of migrations among the multiple hosts that achieves a lowest overall latency between a set of peripherals (e.g., a single peripheral or a subset of peripherals) and the gaming device.

The model 240 can be trained using a variety of training techniques to improve host migration and management, including supervised and unsupervised learning techniques. In some implementations, the model 240 can be trained using hybrid-learning techniques. The parameters or weights of the model 240 can be adjusted based on an analysis of network parameters for the gaming computer network and previously generated control outputs, e.g., to determine if a control output to migrate a host achieved a target reduction in latency, packet loss rate, etc. By doing so, the model 240 can improve its accuracy in migrating hosts in the gaming computer network. In some implementations, the model 240 includes one or more fully or partially connected layers and each of the layers can include one or more parameter values indicating an output of the layers.

The hardware processor 242 may include one or more processors, such as general-purpose processors (e.g., a microprocessor), special-purpose processors (e.g., an application-specific integrated circuit (ASIC) or digital-signal processor (DSP)), programmable-logic devices (e.g., a field programmable gate array (FPGA)), or any other processor components. The hardware processor 242 may carry out one or more instructions using one or more arithmetic, logical, and/or input/output operations. Though the hardware processor 242 is illustrated as a single component, the hardware processor 242 may be integrated in whole or in part with other components of the host controller 202 or other components of the gaming device 204.

The controller data storage 246 may be an example of a non-transitory computer-readable medium that can be configured to store instructions, when executed by the hardware processor 242, cause the host controller 202 to perform several processes for migrating and managing hosts. The host controller 202 may be implemented using a combination of software and hardware. The host controller 202 may, for example, be implemented as one or more hardware processors configured to execute one or more algorithms.

Referring to the antenna of a host, e.g., antennas 218-1 through 218-N, the type and configuration of the antenna(s) can depend in part, for example, on computing demands of the host and any connected peripheral devices. For example, type and configuration of antenna can depend in part on form factor of the host, a placement of the antenna within the host, location of the host in the gaming environment, and the like. The type and configuration of the antenna can include directional vs. omnidirectional antenna, a size of antenna, a range of broadcast of the antenna, operating power of the antenna, and the like.

In some implementations, a type and configuration of the antenna is selected based in part on a location of the host including the antenna(s) with respect to the gaming environment. A location of the host within the gaming environment, e.g., with respect to each other gaming device in the gaming environment, can dictate a relative distance, e.g., average range of distances, of the antenna to one or more other peripheral devices in the gaming environment gaming ecosystem and a degree to which the line-of-sight between the antenna and the one or more other peripheral devices of the gaming system is obstructed. For example, a first host, e.g., host 110-1 can have a first location and orientation for the antenna within the first host, and a second host, e.g., host 110-2 can have a second location and orientation for the antenna within the second host.

In some implementations, the peripheral devices, e.g., peripheral device 206-1 through 206-N can be located in close proximity to the user. Examples of such peripheral devices can include, headsets, VR headsets, headphones, wearable devices, and the like. In such cases, the location of the type and configuration of the antenna for the host is selected based in part on a location of the user within the gaming environment. For example, a host can be selected in part on a relative proximity of the peripheral device to a user of the gaming system and a degree to which the line-of-sight, e.g., within a visual range, between the antenna of the host and the user is obstructed. In some examples, the host can be selected for migration based on being within a particular range, e.g., less than 1 meter range of distance, of the user and/or the gaming system, e.g., console device, mobile gaming device, desktop, laptop, etc. In some implementations, the host can be selected for migration based on being within a threshold degree of obstruction, e.g., less than 10%, 5%, 2%, 1% of the signal between the antenna of the host and the user is obstructed.

In some implementations, a type and configuration of an antenna is selected in part based on form factor of the host that includes the antenna. For example, a maximum size of the antenna can be selected in part based on the available space within the form factor of the host, e.g., a maximum size of an antenna within a mouse can be less than a maximum size of an antenna within a keyboard or monitor. In some implementations, a type and configuration of an antenna can depend in part on power requirements and available power supply for the antenna. For example, limitations on available power to operate the antenna can determine a maximum size of the antenna. In general, further distance and/or increased obstruction of line-of-sight between antenna and the one or more other peripheral devices can require increased power from the antenna to maintain a stable, e.g., reliable, wireless data communication channel.

In some implementations, type and configuration of an antenna is selected based on power demands for the signals of the antenna to maintain at least a threshold connectivity between the host and one or more other peripheral devices. A threshold connectivity can be, for example, a connectivity distance range, a target latency, a target resilience of the connectivity, or the like. For example, a target range for connectivity can be 0-3 meters, e.g., that the connection is maintained for a range of separation between host and peripheral and/or host and gaming device of 0-3 meters. In another example, a threshold connectivity can be defined as a latency of the wireless data communication that is within a threshold performance of a wired connection, e.g., where a difference in performance between the wireless connection and a wired connection is indiscernible by a user. In another example, a threshold connectivity can be defined as a resilience of the connection to external aggressors can be within a threshold performance of another type of wireless connectivity protocol, e.g., Bluetooth, from 3-30 meters.

In some implementations, the host is retained within a form factor of a monitor, e.g., a computer monitor, television, or another type of display in data communication with the gaming system, e.g., console device. The antenna of the host device can be within the monitor, in which the antenna can be a directional antenna or omnidirectional antenna and oriented to transmit/receive a frustum aligned with the plate of the monitor display. The size of the antenna of the host within the monitor can depend on (i) an average distance of the monitor to the one or more other peripheral devices, e.g., peripheral devices located in close proximity to the user, (ii) an average interference or obstruction of the RF signal from the antenna within the form factor of the monitor to the one or more other peripheral devices, (iii) a size of the power supply available to power the antenna, e.g., a power supply of the monitor, or (iv) a combination of any of these.

In some implementations, the host is retained within a form factor of a keyboard, e.g., a wired keyboard, in data communication with the gaming system, e.g., console device. The antenna of the host can be within the keyboard, in which the antenna can be a directional antenna or omnidirectional antenna and oriented to transmit/receive in an arc perpendicular to a top surface, e.g., surface including the keys, of the keyboard. The size of the antenna of the host within the keyboard can depend on (i) an average distance of the keyboard to the one or more other peripheral devices, e.g., peripheral devices located in close proximity to the user, (ii) an average interference or obstruction of the RF signal from the antenna within the form factor of the keyboard to the one or more other peripheral devices, (iii) a size of the power supply available to power the antenna, e.g., a power supply of the keyboard, or (iv) a combination of any of these.

In some implementations, a host can include one or more USB ports and can be configured as a hub for multiple peripheral devices. For example, the host can include a first USB port in data communication with the peripheral device for transmitting control signals to the peripheral device, a second USB port in data communication with the peripheral device for receiving signals from the peripheral device, e.g., signals including feature data of the gaming environment, and one or more additional USB ports. The one or more additional USB ports can be configured to connect to one or more additional peripheral devices through respective data communication channels. In some instances, the one or more additional USB ports can be configured to connect to one or more additional peripheral devices through respective wired data communication channels. The host can be configured to transmit/receive data through wired data communication channel from other hosts, and provide/receive the respective data through respective ones of the USB ports to the various connected devices.

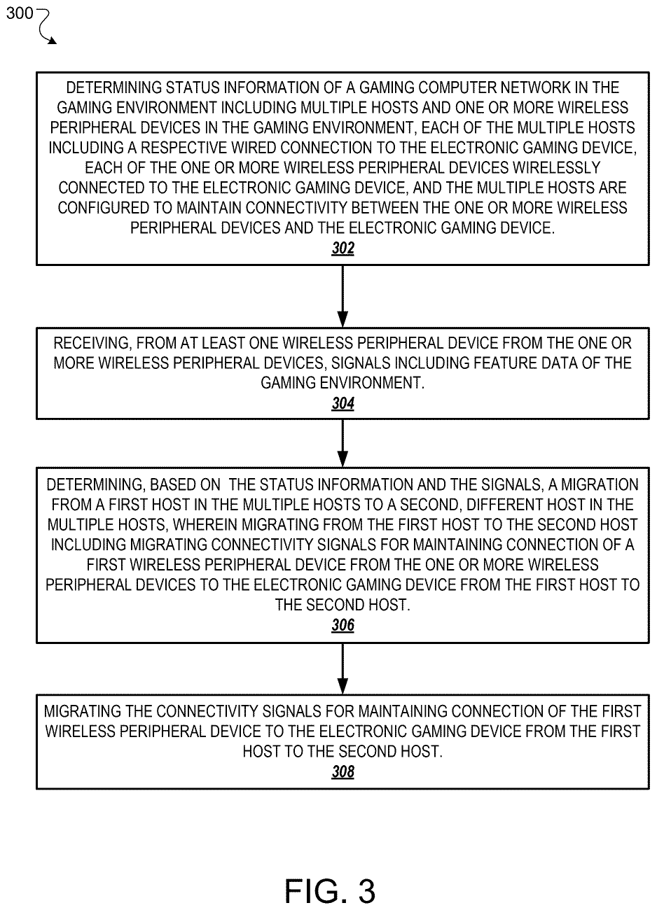

FIG. 3 is a flow diagram of an example process 300 for managing and migrating connectivity signals among multiple hosts in a gaming computer network for a gaming environment. The process 300 can be performed by an electronic gaming device, e.g., gaming device 104, gaming device 204, in a gaming environment. Examples of hosts can include consoles, mobile gaming devices, personal computers, laptops, link adapters, displays, monitors, webcams, among other types of devices.

The process 300 includes determining status information of a gaming computer network in the gaming environment (302). The gaming computer network includes multiple hosts, such as host 110-1 through 110-3 described in FIG. 1A and hosts 150-1 through 150-6 described in reference to FIG. 1B, and one or more wireless peripheral devices, e.g., peripheral devices 156-1 through 156-5. Each of the multiple hosts having a respective wired connection to the gaming device and each of the one or more wireless peripheral devices wirelessly connected to the gaming device. The multiple hosts can be configured to maintain connectivity between the one or more wireless peripheral devices and the gaming device. In some implementations, the gaming device includes a first antenna, e.g., antenna 218-1, and each of the multiple hosts includes a respective antenna, e.g., antenna 218-2 through 218-N, described in reference to FIG. 2 above.

The process 300 includes receiving, from at least one wireless peripheral device from the one or more wireless peripheral devices, signals including feature data of the gaming environment (304). In some implementations, the at least one wireless peripheral device, e.g., peripheral device 206-1, is configured to capture the feature data of the gaming environment, generate the signals representing the feature data, and transmit the signals to the gaming device, as described in reference to FIG. 2 above.

In some implementations, the at least one wireless peripheral device is configured to capture physical input data of an input from a user in the gaming environment, e.g., such as a handheld controller 156-1 or a steering wheel and pedal controller 156-5. In some implementations, the at least one wireless peripheral device is configured to capture positional data of a user in the gaming environment, e.g., such as a set of VR handheld controllers 156-3 and/or a VR headset 156-4. In some implementations, the at least one wireless peripheral device is configured to capture audio data of a user in the gaming environment. Examples of wireless peripheral device for capturing audio data can includes earbuds, headsets, headphones, e.g., headphones 156-2.

The process 300 includes determining, based on the status information and the signals, a migration from a first host in the multiple hosts to a second host in the multiple hosts different from the first host (306). Migrating from the first host to the second host includes migrating connectivity signals for maintaining connection of a first wireless peripheral device from the one or more wireless peripheral devices to the gaming device from the first host to the second host.

In some implementations, determining the migration based on the status information and the signals includes determining that a parameter relating to connectivity between the first wireless peripheral device and the gaming device exceeds a threshold value. In some implementations, the parameter is one of (i) latency, (ii) bandwidth utilization, or (iii) packet loss rate.

The process 300 includes migrating the connectivity signals for maintaining connection of the first wireless peripheral device to the gaming device from the first host to the second host (308). In some implementations, migrating the connectivity signals for maintaining connection of the first wireless peripheral device to the gaming device from the first host to the second host includes switching communication of signals from a first frequency channel in multiple frequency channels to a second frequency channel in the multiple frequency channels. The second frequency channel can be different from the first frequency channel.

In some implementations, the process 300 includes detecting, based on the feature data from the signals, a change in the status information of the gaming computer network in the gaming environment. In some implementations, the process 300 includes transmitting, by the first antenna of the gaming device, a waveform for monitoring a parameter representing connectivity of one or both of (i) a particular host from the multiple hosts, or (ii) a particular wireless peripheral device from the one or more wireless peripheral devices, of the gaming computer network. In some implementations, the method includes receiving, by the gaming device, a waveform response including data indicating the status information for the one or both of (i) the particular host or (ii) the particular wireless peripheral device.

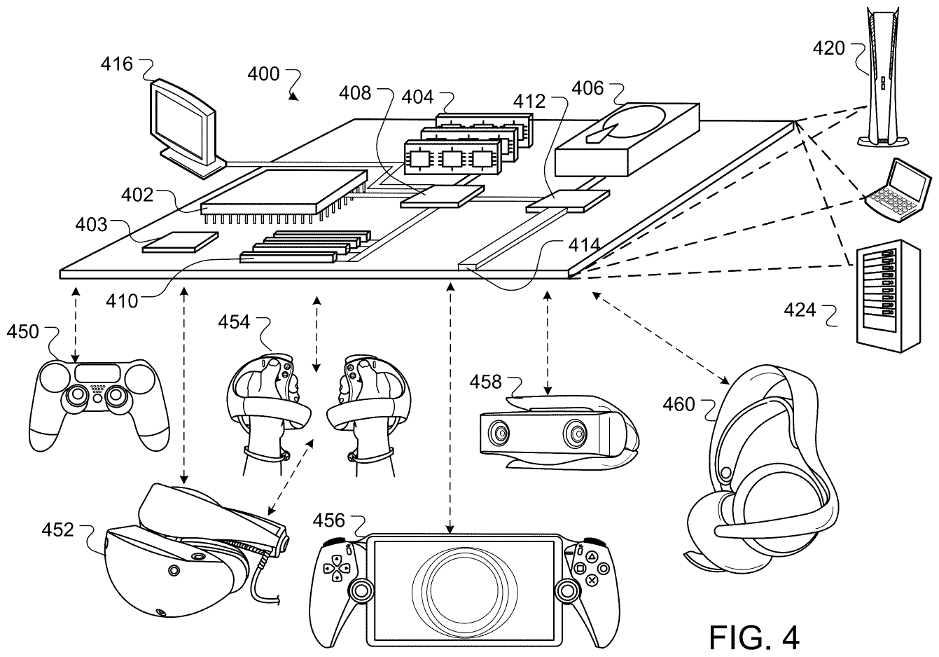

FIG. 4 shows an example of a computing device 400 and associated accessories that can be employed to execute implementations of the present disclosure. The computing device 400 can be a gaming console 420, such as PS5®, PS4®, PS3®, PS2® etc., or as one or more servers 424 or as a rack within a server. In some implementations, the computing device 400 may be implemented as a personal computer such as a laptop computer 422. In some implementations, the computing device 400 can be implemented as a mobile device such as the connected handheld gaming device 456. In some implementations, a computing device can include one or more of the computing device 400 and an entire system may be made up of multiple computing devices communicating with each other. For example, a gaming system can include one or more of a gaming console 420, one or more accessories, and a remote platform such as a cloud-based platform implemented on one or more servers 424. The computing device can also include a desktop computer, a workstation, a personal digital assistant, a server, a blade server, a mainframe, or other appropriate type of computer. The components shown here, their connections and relationships, and their functions, are examples only, and are not limiting.

In various implementations, the computing device 400 includes some combination of one or more processors or central processing units (CPUs) 402, one or more graphic processing units (GPUs) 403, memory 404, one or more storage devices 406, a high-speed interface 408, and/or a low-speed interface 412. In some implementations, the high-speed interface 408 connects to the memory 404 and multiple high-speed expansion ports 410. In certain implementations, the low-speed interface 412 connects to a low-speed expansion port 414 and the storage device 404. In some implementations, the high-speed interface 408 connects to the storage device 404. Each of the processor 402, the GPU 403, the memory 404, the storage device 406, the high-speed interface 408, the high-speed expansion ports 410, and the low-speed interface 412, are interconnected using various buses, and may be mounted on a common motherboard or in other manners as appropriate. The processor 402 can process instructions for execution within the computing device 400, including instructions stored in the memory 404 and/or on the storage device 406 to display graphical information for a graphical user interface (GUI) on an external input/output device, such as a display 416 coupled to the high-speed interface 408. In other implementations, multiple processors and/or multiple buses may be used, as appropriate, along with multiple memories and types of memory. In addition, multiple computing devices may be connected, with each device providing portions of the necessary operations (e.g., as a server bank, a group of blade servers, or a multi-processor system).

The memory 404 stores information within the computing device 400. In some implementations, the memory 404 includes a volatile memory unit or units. Alternatively, or in addition, the memory 404 can include a non-volatile memory unit or units. The memory 404 may also include another form of a computer-readable medium, such as a magnetic or optical disk. In some implementations, the memory 404 includes Graphics Double Data Rate (GDDR) memory such as GDDR6 memory configured to provide a unified memory architecture with a high bandwidth. In some implementations, the memory can include high speed memory such as GDDR2, GDDR3, GDDR4, GDDR5, GDDR5X, GDDR6X, GDDR6W or GDDR7. Such high-speed memory can facilitate rapid data access and seamless multitasking, supporting gaming and multimedia applications.

The storage device 406 provides mass storage for the computing device 400. In some implementations, the storage device 406 may be or include a computer-readable medium, such as a hard disk device, an optical disk device, a flash memory, or other similar solid-state memory device, or an array of devices, including devices in a storage area network or other configurations. In some implementations, the storage device 406 can include a high capacity solid-state drive (SSD) configured to support a high throughput (e.g., 5.5 GB/s or more). Such an SSD can facilitate fast load times, enabling near-instantaneous game booting, level transitions, and asset streaming. In some implementations, the storage device 406 can be configured to support expandable storage via compatible non-volatile memory express (NVMe) SSDs. Instructions can be stored in an information carrier, and when executed by one or more processing devices, such as processor 402, perform one or more methods, such as those described above. The instructions can also be stored by one or more storage devices, such as non-transitory computer-readable or machine-readable mediums, such as the memory 404, the storage device 406, or memory on the processor 402. The instructions can constitute software for providing interactive game play on a user interface such as a graphical user interface (GUI) presented on the display 416.

The high-speed interface 408 generally manages bandwidth-intensive operations for the computing device 400, while the low-speed interface 412 generally manages lower bandwidth-intensive operations. Such allocation of functions is an example only. In some implementations, the high-speed interface 408 is coupled to the memory 404, the display 416 (e.g., through a graphics processor or accelerator), and to the high-speed expansion ports 410, which accepts various expansion cards. In the implementation, the low-speed interface 412 is coupled to the storage device 406 and the low-speed expansion port 414. The low-speed expansion port 414, which may include various communication ports (e.g., Universal Serial Bus (USB) Type-A and Type-C ports, High-Definition Multimedia Interface (HDMI) ports, Bluetooth, Ethernet, wireless Ethernet) may be coupled to one or more input/output and/or accessory devices. Such input/output and accessory devices can include a controller 450 such as a DualSense®, DualShock®, or Access™ controllers for PlayStation® devices, a virtual reality (VR) or augmented reality (AR) headset 452 such as the PS VR2 headset, accessory controllers 454 such as PS VR2 Sense™, a handheld gaming device 456 such as PlayStation Portal®, a camera 458, and/or an earphone/headphone set 460 such as the PULSE Elite™ headset or the Pulse Explore™ earbuds. In some implementations, the computing device 400 includes one or more acoustic transducers, and/or is connected to one or more external acoustic transducers such as one or more speakers associated with the display 416.

The processor 402 can be implemented as a chipset of chips that include separate and multiple analog and digital processors. For example, the processor 402 can be a multi-core processor that supports high-speed processing and enables complex computational tasks, real-time physics simulations, and advanced artificial intelligence (AI) capabilities. In one example, the processor 402 includes at least 8 cores, at least 16 threads, and operates at variable frequencies around 3.5 GHz or more. In some implementations, the processor 402 may be a Complex Instruction Set Computers (CISC) processor, a Reduced Instruction Set Computer (RISC) processor, or a Minimal Instruction Set Computer (MISC) processor.

In some implementations, the GPU 403 includes a custom GPU that supports an advanced architecture such as the RDNA 2 architecture developed by AMD. In certain examples, the GPU 403 includes at least 36 compute units running at speeds of 2 GHz or more, and delivers performance of at least 10 teraflops. The GPU 403 can be configured to support high quality graphics rendering. For example, the GPU 403 can be configured to support hardware-accelerated ray tracing for enhanced realism in lighting and reflections, thereby providing a highly immersive gaming experience.

The computing device 400 can be configured to interact with one or more connected input/output or accessory device in providing the gaming experience. In some implementations, the computing device communicates with a handheld controller 450—e.g., a DualSense®, DualShock®, or Access™ controller for PlayStation® devices—to provide the gaming experience. The controller 450 can feature a high-fidelity haptic feedback system with one or more actuators that simulate a wide range of tactile sensations. In some implementations, the controller 450 includes one or more adaptive triggers that adjust resistance based on in-game actions to provide for a realistic feel.

The ergonomic design of the controller 450 can allow for comfortable use even in long gaming sessions. For example, the controller 450 can include textured grips and an optimized button layout. In some implementations, the controller 450 includes one or more of: integrated motion sensors, a high-resolution touchpad, and a built-in microphone array. The controller 450 includes an array of buttons, joysticks, and other controls that allow a user to interact with the computing device 400 to participate in interactive gameplay presented, for example, on a display device such as the display 416. The controller 450 can be powered by one or more regular or rechargeable batteries and supports both wireless and wired connectivity with the computing device 400, for example, via Bluetooth, WiFi, USB-C etc., or via a proprietary connection such as PlayStation Link™. In some implementations, the controller 450 includes a light bar and player indicators for visual feedback and customization.

In some implementations, the input/output or accessory device includes a VR/AR headset 452. One example of such a headset is the PlayStation VR2 (PS VR2) headset that is configured to provide an immersive and interactive gaming experience. In some implementations, the headset 452 features dual displays, e.g., organic light emitting device displays or micro-LED displays, with a combined resolution of 4000 4 2080 pixels or higher—thus providing sharp visuals and a wide field of view.

In some implementations, the VR/AR headset 452 includes eye-tracking technology that enables foveated rendering, by focusing on where the user is looking. In some implementations, the headset 452 includes integrated cameras that facilitate tracking head movements without external sensors. In some implementations, the headset includes haptic feedback for tactile sensations and/or one or more acoustic transducers configured to provide a spatial sound effect the user. The headset 452 can include an adjustable headband and cushioned padding, and can be configured to connect to the computing device 400 either over a wireless network (e.g., over a WiFi® or Bluetooth® connection, or a proprietary connection such as PlayStation Link™) or over a wire such as a USB-C cable.

In some implementations, the headset 452 can be configured to work in conjunction with one or more accessory controllers 454 such as the PlayStation VR2 Sense™ controllers. The accessory controllers 454 can enhance the immersive gaming experience through various features such as advanced haptic feedback for detailed in-game sensations, adaptive triggers with dynamic resistance to simulate real-world actions, and finger touch detection for natural interactions. The ergonomics of the accessory controllers 454 can provide a comfortable experience even during extended gameplay. In some implementations, the accessory controllers include one or more integrated sensors (accelerometer, gyroscope, etc.) and/or cameras to provide motion tracking. The accessory controllers 454 can be configured to connect to the computing device 400 and/or the headset 452 over a wireless connection such as WiFi® or Bluetooth®.

In some implementations, the computing device 400 is connected to a handheld gaming device 456 such as the PlayStation Portal®. The handheld gaming device 456 can be configured to stream games and media from the computing device 400 via a wireless connection such as WiFi® or Bluetooth®. The handheld gaming device 456 includes a high-resolution screen that allows users to play games and/or stream media remotely without using the display 416 connected to the computing device 400. This allows the display to be used for other purposes while the computing device 400 facilitates gameplay on the handheld gaming device 456. In some implementations, the handheld gaming device 456 is configured to act as a streaming receiver without running games natively on the device 456 itself. This makes the handheld gaming device 456 a convenient option for playing games run on the computing device 400, while leaving a TV connected to the computing device 400 free to be used for viewing other media. The handheld gaming device 456 can includes buttons and features similar to (or even same as) the controller 450, thus providing for a similar gaming experience as that with the controller 450.

In some implementations, the input/output or accessory devices includes a camera 458 and/or an earphone/headphone set 460 such as the PULSE Elite™ headset or the Pulse Explore™ earbuds. The camera 458 can be used to track user-movements, which in turn can be used as an input to an interactive game being executed on the computing device 400. The earphone/headphone set 460 can be used to provide audio feedback/output to a user from the computing device 400. In some implementations, the earphone/headphone set 460 can include a microphone to receive spoken inputs/instructions that in turn can be used to control an interactive game being executed on the computing device 400.

While this specification contains many specific implementation details, these should not be construed as limitations on the scope of what is being claimed, which is defined by the claims themselves, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A computer-implemented method comprising:
determining status information of a gaming computer network in a gaming environment, wherein the gaming computer network comprises multiple hosts and one or more wireless peripheral devices in the gaming environment, wherein each of the multiple hosts comprises a respective wired connection to an electronic gaming device, wherein each of the one or more wireless peripheral devices is wirelessly connected to the electronic gaming device, and wherein the multiple hosts are configured to maintain connectivity between the one or more wireless peripheral devices and the electronic gaming device;
receiving, from at least one wireless peripheral device of the one or more wireless peripheral devices, signals comprising feature data of the gaming environment;
determining, based on the status information and the signals, a migration from a first host in the multiple hosts to a second host in the multiple hosts different from the first host, wherein migrating from the first host to the second host comprises migrating connectivity signals for maintaining connection of a first wireless peripheral device from the one or more wireless peripheral devices to the electronic gaming device from the first host to the second host, wherein the first host comprises a wired connection to the second host; and
migrating the connectivity signals for maintaining connection of the first wireless peripheral device to the electronic gaming device from the first host to the second host.

2. The method of claim 1, wherein determining the migration based on the status information and the signals comprises determining that a parameter relating to connectivity between the first wireless peripheral device and the electronic gaming device exceeds a threshold value.

3. The method of claim 2, wherein the parameter is one of (i) latency, (ii) bandwidth utilization, or (iii) packet loss rate.

4. The method of claim 1, further comprising detecting, based on the feature data from the signals, a change in the status information of the gaming computer network in the gaming environment.

5. The method of claim 1, wherein the electronic gaming device comprises a first antenna, and each of the multiple hosts comprises a respective antenna.

6. The method of claim 5, wherein migrating the connectivity signals for maintaining connection of the first wireless peripheral device to the electronic gaming device from the first host to the second host comprises switching communication of signals from a first frequency channel in multiple frequency channels to a second frequency channel in the multiple frequency channels, wherein the second frequency channel is different from the first frequency channel.

7. The method of claim 5, further comprising:
transmitting, by the first antenna of the electronic gaming device, a waveform for monitoring a parameter representing connectivity of one or both of (i) a particular host from the multiple hosts, or (ii) a particular wireless peripheral device from the one or more wireless peripheral devices, of the gaming computer network.

8. The method of claim 7, further comprising:
receiving, by the electronic gaming device, a waveform response comprising data indicating the status information for the one or both of (i) the particular host or (ii) the particular wireless peripheral device.

9. The method of claim 1, wherein the at least one wireless peripheral device is configured to:
capture the feature data of the gaming environment;
generate the signals representing the feature data; and
transmit the signals to the electronic gaming device.

10. The method of claim 1, wherein the at least one wireless peripheral device is configured to capture physical input data of an input from a user in the gaming environment.

11. The method of claim 1, wherein the at least one wireless peripheral device is configured to capture positional data of a user in the gaming environment.

12. The method of claim 1, wherein the at least one wireless peripheral device is configured to capture audio data of a user in the gaming environment.

13. A system for a gaming environment, the system comprising:
an electronic gaming device configured to determine status information of a gaming computer network in the gaming environment;
wherein the gaming computer network comprises multiple hosts and one or more wireless peripheral devices in the gaming environment, wherein each of the multiple hosts comprises a respective wired connection to the electronic gaming device, wherein each of the one or more wireless peripheral devices is wirelessly connected to the electronic gaming device, and wherein the multiple hosts are configured to maintain connectivity between the one or more wireless peripheral devices and the electronic gaming device;
wherein the electronic gaming device is further configured to:
receive, from at least one wireless peripheral device of the one or more wireless peripheral devices, signals comprising feature data of the gaming environment;
determine, based on the status information and the signals, a migration from a first host in the multiple hosts to a second host in the multiple hosts different from the first host, wherein migrating from the first host to the second host comprises migrating connectivity signals for maintaining connection of a first wireless peripheral device from the one or more wireless peripheral devices to the electronic gaming device from the first host to the second host, wherein the first host comprises a wired connection to the second host; and
migrate the connectivity signals for maintaining connection of the first wireless peripheral device to the electronic gaming device from the first host to the second host.

14. The system of claim 13, wherein determining the migration based on the status information and the signals comprises determining that a parameter relating to connectivity between the first wireless peripheral device and the electronic gaming device exceeds a threshold value, wherein the parameter is one of (i) latency, (ii) bandwidth utilization, or (iii) packet loss rate.

15. The system of claim 13, wherein the electronic gaming device is configured to detect, based on the feature data from the signals, a change in the status information of the gaming computer network in the gaming environment.

16. The system of claim 13, wherein the electronic gaming device comprises a first antenna, and each of the multiple hosts comprises a respective antenna.

17. The system of claim 13, wherein migrating the connectivity signals for maintaining connection of the first wireless peripheral device to the electronic gaming device from the first host to the second host comprises switching communication of signals from a first frequency channel in multiple frequency channels to a second frequency channel in the multiple frequency channels, wherein the second frequency channel is different from the first frequency channel.

18. The method of claim 1, wherein the at least one wireless peripheral device is configured to capture one or more of (i) physical input data of an input, (ii) positional data, (iii) audio data, of a user in the gaming environment.

19. One or more non-transitory computer-readable storage media that store instructions that, when executed by one or more processors of an electronic gaming device, cause the one or more processors to perform operations comprising:
determining status information of a gaming computer network in a gaming environment, wherein the gaming computer network comprises multiple hosts and one or more wireless peripheral devices in the gaming environment, wherein each of the multiple hosts comprises a respective wired connection to the electronic gaming device, wherein each of the one or more wireless peripheral devices is wirelessly connected to the electronic gaming device, and wherein the multiple hosts are configured to maintain connectivity between the one or more wireless peripheral devices and the electronic gaming device;
receiving, from at least one wireless peripheral device of the one or more wireless peripheral devices, signals comprising feature data of the gaming environment;
determining, based on the status information and the signals, a migration from a first host in the multiple hosts to a second host in the multiple hosts different from the first host, wherein migrating from the first host to the second host comprises migrating connectivity signals for maintaining connection of a first wireless peripheral device from the one or more wireless peripheral devices to the electronic gaming device from the first host to the second host, wherein the first host comprises a wired connection to the second host; and
migrating the connectivity signals for maintaining connection of the first wireless peripheral device to the electronic gaming device from the first host to the second host.

20. The one or more non-transitory computer-readable storage media of claim 19, wherein determining the migration based on the status information and the signals comprises determining that a parameter relating to connectivity between the first wireless peripheral device and the electronic gaming device exceeds a threshold value.
